(19) United States
(12) Patent Application Publication
(10) Pub. No.: US 2015/0007163 A1
(43) Pub. Date: Jan. 1, 2015

(54) MONITORING THE DEPLOYMENT OF CODE ONTO A SYSTEM

(71) Applicant: International Business Machines Corporation, Armonk, NY (US)

(72) Inventors: Itzhack Goldberg, Hadera (IL); Jonathan D. Herd, Beaconsfield (GB); Michael Shevrin, Kfar Yona (IL); Neil Sondhi, Budapest (HU)

(21) Appl. No.: 13/927,142

(22) Filed: Jun. 26, 2013

(51) Int. Cl. G06F 9/445

(52) U.S. Cl. CPC G06F 8/65
USPC 717/172

(57) ABSTRACT

A serial identification number of a system, the system having a system type and a system status is received. A database is accessed to obtain code detail records of the system associated with the serial identification number. Code details of the system are received. The serial identification number, the code detail records, and the code details of the system are analyzed to identify the system type and the system status. A suitable system update for the system, based on the system type and the system status is identified.

FIELD OF INVENTION

This disclosure relates generally to servicing systems, and more specifically, regards the issue of proactive and preventive code monitoring, repairs, and updates for systems.

### BACKGROUND

System services are a configuration of technology designed to deliver services that satisfy the needs, wants, or aspirations of system owners. There is an increasing dependency on IT infrastructure and reliable system performance. Individuals want to keep their systems up to date, but may lack the resources to fully develop and maintain support for machine code updates. Furthermore, new issues arise that continue to affect system performance and increase the difficulty to troubleshoot problems.

### SUMMARY

Disclosed herein are embodiments of a method for monitoring the deployment of code onto a system. In an embodiment, a method includes an operation where a serial identification number of a system, the system having a system type and a system status, is received. In addition, the method may include an operation where a database is accessed to obtain code detail records of the system associated with the serial identification number. Also, the method may include an operation where code details of the system are received. Furthermore, the method may include an operation where the serial identification number, the code detail records, and the code details of the system are analyzed to identify the system type and the system status. In an embodiment, a suitable system update for the system may be identified based on the system type and the system status.

Also, disclosed herein are embodiments of a system for monitoring the deployment of code onto a system. In an embodiment, a recipient tool is adapted to receive a serial identification number of a system and code details of the system, the system having a system type and a system status. In addition, a database may be included, adapted to provide code detail records of the system associated with the serial identification number. Also, an analyzing tool may be included, adapted to analyze the serial identification number, the code detail records, and the code details of the system to identify the system type and the system status. Furthermore, an identification tool may be included, adapted to identify a suitable system update for the system, based on the system type and the system status.

Also, disclosed herein are embodiments of a computer-readable storage medium encoded with instructions for monitoring the deployment of code onto a system. In an embodiment, a computer-readable storage medium may include instructions for receiving a serial identification number of a system, the system having a system type and a system status. In addition, a computer-readable storage medium may include instructions to access a database to obtain code detail records of the system associated with the serial identification number. Also, the computer-readable storage medium may include instructions for receiving code details of the system. Furthermore, the computer-readable storage medium may include instructions for analyzing the serial identification number, the code detail records, and the code details of the system to identify the system type and the system status. In an embodiment, the computer-readable storage medium may include instructions for identifying a suitable system update for the system based on the system type and the system status.

### BRIEF DESCRIPTION OF THE DRAWINGS

FIG. 1 is a flow diagram of an example method for monitoring the deployment of code onto a system, consistent with embodiments of the present disclosure.

FIG. 2 is a more detailed flow diagram for an example method for determining the system type, system status, and whether there are any suitable system updates for the system, consistent with embodiments of the present disclosure.

FIG. 3 is a flow diagram of an example method for recalling a system update and repairing the system, consistent with embodiments of the present disclosure.

FIG. 4 illustrates an example system for monitoring the deployment of code onto a system, consistent with embodiments of the present disclosure.

FIG. 5 depicts a high-level block diagram of an example system according to an embodiment of the invention, consistent with embodiments of the present disclosure.

### DETAILED DESCRIPTION

Technology has produced a number of advancements that have changed the way we work and the way we live. It has provided us with modern conveniences that have simplified tasks that were once arduous and required great skill. However, technology has also created a world of great complexity as we become more reliant on machines and devices. Today, the ability to access reliable information in a timely manner is imperative to our daily lives, the success of businesses, and the operation of our society as a whole. Therefore, to satisfy this demand for timely and reliable information, individuals with expertise in managing and monitoring the machines and devices that handle this information must be given the resources necessary to address issues and problems in the most timely and efficient manner.

Systems are constantly being repaired, updated, and modified. These interruptions create downtime that has an effect on the productivity of the individuals dependent on the systems. These individuals and Information Technology staffs are generally responsible for troubleshooting problems that occur to their systems. However, as networks continue to grow both in size and complexity, it has become extremely labor-intensive to not only diagnose problems as they occur, but also predict possible future problems and address them before they occur. Now, there are designated personnel that can assist individuals and Information Technology staffs to troubleshoot problems and proactively help them address future problems that may cause downtime of systems.

The issue, therefore, is a proactive and preventive approach to monitoring, diagnosing, repairing, and updating the code details of systems. One of the most powerful means that allows personnel to be proactive and address issues at customer sites, is to advise the relevant customers of problems found in their current code details and commence a corrective action as soon as possible. To that end, a call-home function is used which reports back to a vendor service of the current code details of the system which includes essential information, such as the current code-level of the system.

Code-release downloads may not be monitored as to who downloaded them and for what clients or systems. One way to identify a system is by its unique serial identification number. The serial identification number can be grouped with the current code details of the system and a history of code details of the system can be searched for based upon the unique serial identification number. The vendor then has the ability to generate a unique code delivery suitable just for a particular system or systems. Furthermore, having a custom made code release for a given system or systems, gives development better control up front and allows for specific repairs to be released just for a particular select number of systems.

However, some systems do not allow the call-home function to be used to report back to a vendor service. For systems that do not allow the call-home function to report back, the vendor may not have the information necessary to generate a unique custom code delivery suitable for the system. Furthermore, it may be difficult for personnel to implement a proactive and preventive approach to monitoring, diagnosing, repairing, and updating the code details of systems if there are multiple systems that do not allow the call-home function to report back to a vendor service. For example, if a recent system update is discovered to be corrupt, personnel may not have the information necessary to find all the systems that installed the system update and proactively notify those systems that they may need to be repaired.

To provide systems with disabled call-home functions custom made code releases and find all the systems in the field that may be infected with a corrupt system update, a system agent may be used. The system agent can gather information necessary, like the code details and the serial identification number of the system, to give personnel the ability to monitor system update installations.

In this detailed description, reference is made to the accompanying drawings, which illustrate example embodiments. It is to be understood that other embodiments may be utilized and structural changes may be made without departing from the scope of the invention. The terminology used herein is for the purpose of describing particular embodiments only and is not intended to be limiting of the invention. In accordance with features of the invention, a method, a system, and a computer program product are provided for monitoring the deployment of code onto a system.

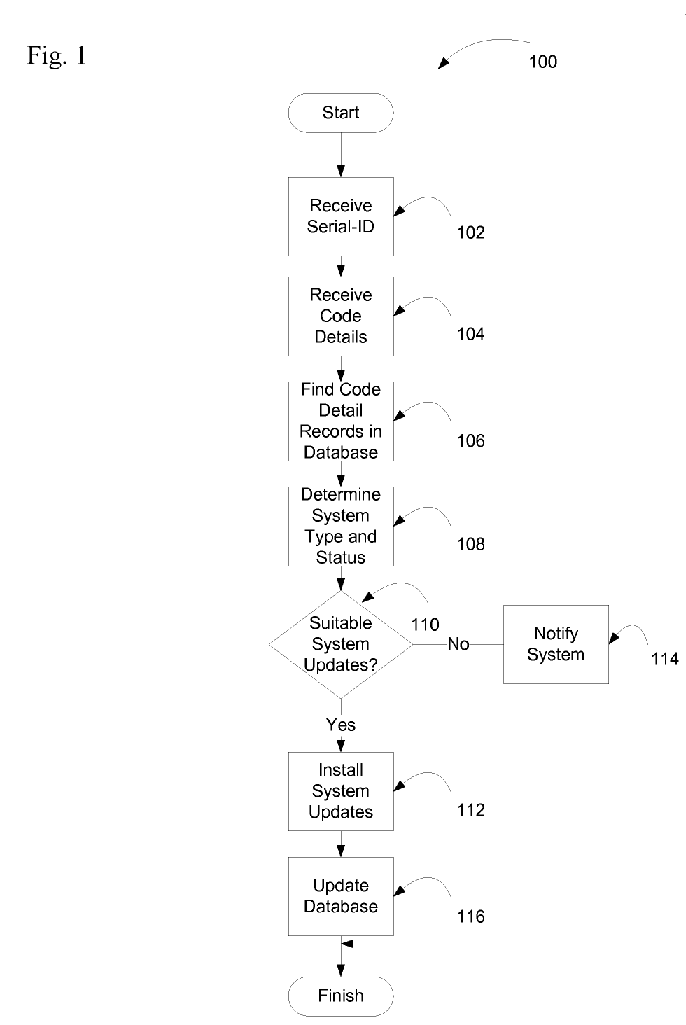

FIG. 1 illustrates a method 100 for monitoring the deployment of code onto a system. In operation 102, a unique serial identification number is received. Consistent with embodiments of the present disclosure, the serial identification number can be received from the system itself. For example, when a system visits a vendor site, the system may send “heartbeat data.” The “heartbeat data” is data that contains a variety of information including the code-level of the system, its configuration and the serial numbers of all the components of the system. From the “heartbeat data” the unique serial identification number can be obtained. In another example, the serial identification number can be received from a system agent. The system agent is used for any guided repair action on the system. It is connected via a network directly to the system and communicates with the system to facilitate the repair action. The system agent can be utilized to gather “heartbeat data” when the agent communicates with the system. The unique serial identification number can then be obtained from the “heartbeat data” provided by the system agent. The system agent may be used to gather the “heartbeat data” of the system for example, if the call-home function, that allows the system to report its “heartbeat data,” is disabled.

In operation 104, the code details of the system are received. In one example, the serial code details can be received from the system itself. For example, when a system visits a vendor site, the system may send “heartbeat data.” The “heartbeat data” contains a variety of information including the code-level of the system, its configuration and the serial numbers of all the components of the system. From the “heartbeat data” the code details can be obtained. In another example, the code details can be received from a system agent. In certain embodiments, the system agent is used for any guided repair action on the system. It can be connected via a network directly to the system and can communicate with the system to facilitate the repair action. The system agent can be utilized to gather “heartbeat data” when the agent communicates with the system. The code details can then be obtained from the “heartbeat data” provided by the system agent. The system agent may be used to gather the “heartbeat data” of the system for example, if the call-home function, that allows the system to report its “heartbeat data,” is disabled.

In operation 106, the code detail records of the system are found. In one example, when the serial identification number of the system is received, an ID file may be created that may include the “heartbeat data” of the system and may be categorized by the serial identification number of the system. A database may then be accessed and information about the system may be identified based on its serial identification number and the identified information may be retrieved. The database may contain past “heartbeat data” of the system and “heartbeat data” may contain code detail records of the system and within the code detail records may be the past code-levels of the system. Furthermore, there may be no information about the system in the database. This may be because the system has never needed repairs or updates. Also, there may be no record of past code levels that has been kept for the system. There may also be other reasons why there is not information about the system in the database.

In operation 108, the system type and system status are determined. In one example the code detail records may disclose updates and repairs that were performed on the system, and along with the serial identification number and the code details, may disclose the system type and the system status. In operation 110, it is determined if there are any suitable updates available for the system. In one example, once the system type and the system status are determined from the serial identification number, the code detail records, and the code details of the system, a search can be performed for a suitable system update. There may be several updates available or there may be no suitable updates available for the system. If a suitable system update is found, the update is installed on the system in operation 112 and a record is stored in the database that reports an update has been installed on the system in operation 116. If there is not a suitable update for the system, the system is notified in operation 114 that there is not a suitable update available for the given system.

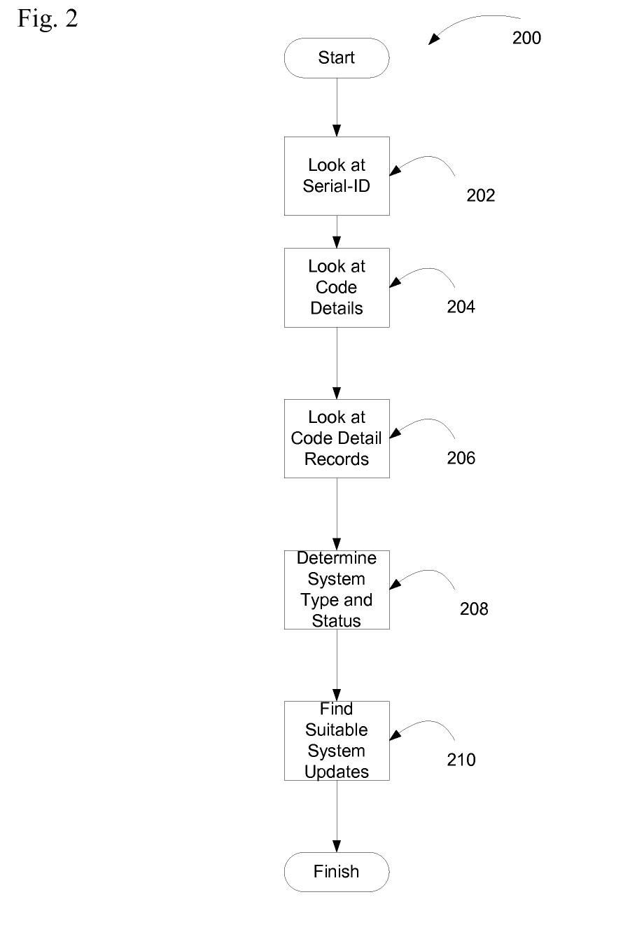

FIG. 2 illustrates a more detailed method 200 for determining the system type, system status, and whether there are any suitable system updates for the system. In operation 202, the unique serial identification number is inspected. A serial identification number can disclose a wealth of information. For example, it can categorize one set of systems from another, it can differentiate between different versions of a given system, and it can separate the same system versions from one another. The serial identification number may not only help identify a system, but it can also provide a way to classify the system in the database and retrieve the information stored in the database under the serial identification number. In operation 204, the code details of the system are inspected. The code details, like the serial identification number, can determine the type of the system and it can also determine the status of the system. For example, the code details may disclose the current code level of the system. This may not only give insight into what code is currently on the system, which may explain what code is suitable for the system, and, therefore, disclose the system, but it may also determine how recent the updates and repairs are on the system and may determine the status of the system.

In operation 206, the code detail records of the system are inspected. The code detail records may be found in the database and may be found by identifying the serial identification number. The code detail records can determine the type of system in the same manner as the system type may be determined from the code details. The code detail records can also give more insight into the status of the system. For example, the system code-level may currently be at a status, as observed from the code details, that indicates there may be a suitable update available for the system. However, the update can only be installed on the system if the system has a past code-level installed. The code detail records may provide the information necessary to determine if the system has the past code-level and the update can be installed on the system or, if the past code-level is not on the system and must be installed before the updated can be installed. The code detail records may also disclose differences between past code-levels and the current code-level found from the code details. This will allow past updates to be installed on the system and proactively avoid future problems with the system.

In operation 208, the system type and the system status are determined. The system type and status may be determined from collecting the information provided by the unique serial identification number, the code details, and the code detail records of the system. After all the information has been collected, the system type and status may be determined with a high level of probability. In operation 210, suitable system updates are found for the system. Because the system type and status may be known with a high level of probability, a custom made code may be available that is only suited for the specific system or systems. Also, problems can be avoided because code that may have been installed on the system, that was not meant for the system, and would need maintenance and repair, may not be installed on the system. Furthermore, if an installation has failed, a ticket may be created to address that a failure has occurred. The system may then be taken care of through the normal process and there may be no need for special attention for proactive and preventive maintenance of the system because of pending problems that may occur in the future.

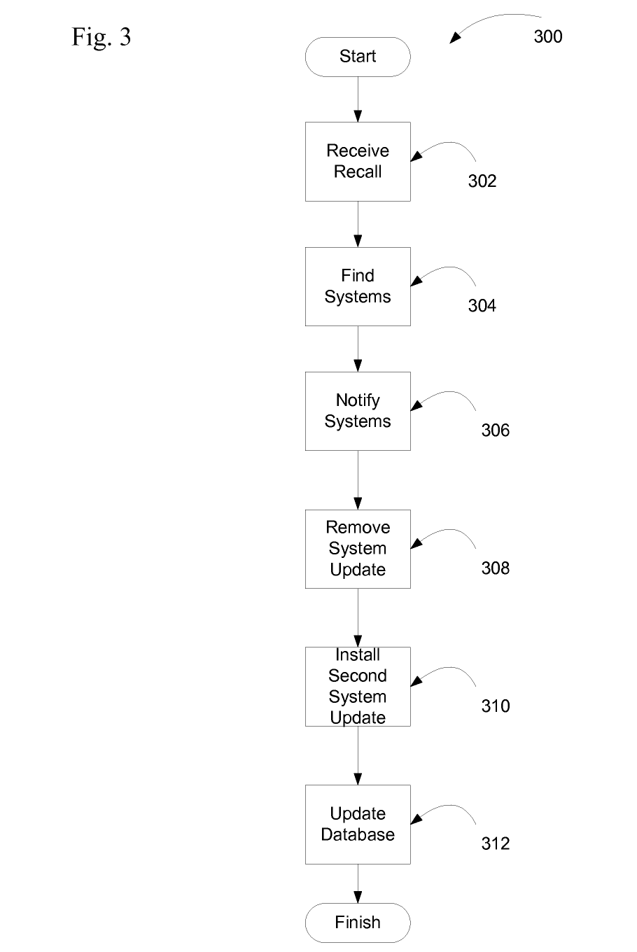

Embodiments of the present disclosure may identify the systems in the field that are monitored, diagnosed, repaired, and updated and the code levels of the systems. Therefore, a proactive solution can be implemented in the event of a “recall” of a system update. FIG. 3 illustrates a method 300 for recalling a system update and repairing the system. In operation 302, a recall of the system update is received. There may be multiple reasons that there is a recall of a system update. For example, a system update may be recalled because the update is corrupt and will not work as designed. Another example is that the system update is not intended for the system that it has been installed on, or the code-level of the system is not at the proper state and the system may not work as intended with the system update. In operation 304, the systems are found that have been installed with the system update that may not operate correctly on the system. The systems can be located using the unique serial identification number that was received and that identifies a record of the installation of the system update in the database.

In operation 306, the systems are notified that there is a recall of the system update. One benefit of this operation can be that, in the event there is a recall, a ticket may be created and sent only to the systems that may be affected by the recalled system update. This may avoid a great alarm to the public at large because it may eliminate the need to announce a recall to those individuals that do not need the recall, such as to everyone who receives support for their systems or to individuals that have installed the system update but do not need to be notified because their system will operate correctly with the system update.

In operation 308, the system update is removed from the system. With the information that was acquired from receiving the code details and obtaining the code detail records in the database, the system update may be removed more efficiently from the system. In operation 310, a second system update may be installed on the system. Similar to the removal 308 of the system update, the information that was acquired from receiving the code details and obtaining the code detail records in the database, a second system update may be created that is more tailored to a given system or systems, or if there are changes that need to be made in the code-level of a system before an update can be properly installed, these changes can be addressed. Furthermore, the installation of the second update 310 may be performed more efficiently. In operation 312, the system detail records are updated in the database. For example, updating the system detail records 312 can include, but are not necessarily limited to, updating that there was a recall of a particular system update, updating that the system update was removed from the system, and updating that there was a second, corrected system update, installed on the system.

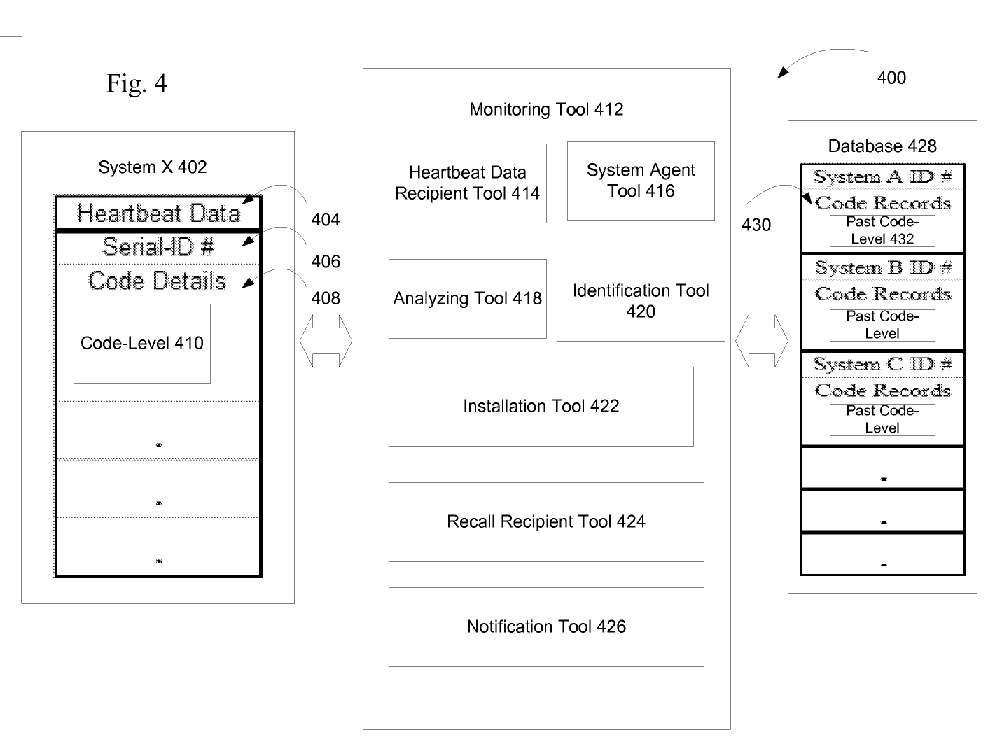

FIG. 4 depicts an example system for monitoring the deployment of code onto a system. According to various embodiments, system 400 can be configured to accommodate a number of systems e.g. System A 402, System B, and System C. Initially, System A402 may access to a customer website to determine whether System A 402 needs to be repaired or updated. One example of an update is an update to the current Code-Level 410 on System A 402. In this example, within System A 402 is the Heartbeat Data 404. The Heartbeat Data 404 is data that contains a variety of information including the Code-Level 410 of System A 402, its configuration, and the serial numbers of all the components of System A 402. In this example, within the Heartbeat Data 404 is a Serial Identification Number 406 of System A 402. Also, within the Heartbeat Data 404 are Code Details 408 of System A 402. In this example, within the Code Details 408 is the Code-Level 410 of System A 402.

In this example, there is a Monitoring Tool 412 that commences monitoring System A 402 when System A 402 visits a customer site. The Monitoring Tool 412 may evaluate System A 402 based on the Heartbeat Data 404 of System A 402. Within the Monitoring Tool 412 may be a Heartbeat Recipient Tool 414. The Heartbeat Recipient Tool 414 may receive the Heartbeat Data 404 of System A 402. The Heartbeat Recipient Tool 414 may receive the Heartbeat Data 404 from System A 402. However, in some embodiments, there may be a System Agent Tool 416 within the Monitoring Tool 412. The System Agent Tool 416 may be used for any guided repair action on System A 402. The System Agent Tool 416 may be connected via a network directly to System A 402 and may communicate with System A 402 to facilitate a repair action. The System Agent Tool 416 can be utilized to gather the Heartbeat Data 404 when the System Agent Tool 416 communicates with System A 402. The System Agent Tool 416 may be used to gather the Heartbeat Data 404 of System A 402 for example, if the call-home function, that allows System A 402 to report the Heartbeat Data 404, is disabled.

In this example, after the System Agent Tool 416 has gathered the Heartbeat Data 404, the Heartbeat Data Recipient Tool 414 may receive the Heartbeat Data 404 from the System Agent Tool 416.

In this example, within the Monitoring Tool 412 is an Analyzing Tool 418. After the Heartbeat Data Recipient Tool 414 has received the Heartbeat Data 404, the Analyzing Tool 418 may analyze the Serial Identification Number 406 and the Code Details 408 within the Heartbeat Data 404 and also the Code Detail Records 430 of System A 402 in the Database 428. The Analyzing Tool 418 may observe the current Code-Level 410 and the Past Code-Levels 432 of System A 402, it may observe the disparities between the current Code-Level 410 and the Past Code-Levels 432 of System A, and it may identify the system type and the system status of System A 402. In this example, when the system type and the system status have been determined, an Identification Tool 420 can search for suitable updates for System A 402. The Identification Tool 420 may find multiple updates, one update, or no suitable updates available for System A 402 based on the determination of the type and status of System A 402 by the Analyzing Tool 418. Furthermore, in this example, if a suitable system update has been found by the Identification Tool 420, an Installation Tool 422 may install the update on System A 402 and update the Code Detail Records 430 of System A 402 in the Database 428.

In this example, if there is a recall on a system update, the Recall Recipient Tool 424 may check the Database 428 for the Code Detail Records 430 for System A 402. If the Code Detail Records 430 show that the recalled system update was installed on System A 402, a Notification Tool 426 may notify System A 402 that there is a recall on a system update that was installed on System A 402. The Analyzing Tool 418 may analyze the Serial Identification Number 406, the Code Details 408, and the Code Detail Records 430 of System A 402 to determine the system type and system status of System A 402. The Identification Tool 420 may then search for suitable system repairs and updates for System A 402. In this example, if a suitable system repair or update is available for System A 402, the Installation Tool 422 may install the repair or update on System A 402 and update the Code Detail Records 430 of System A 402 in the Database 428.

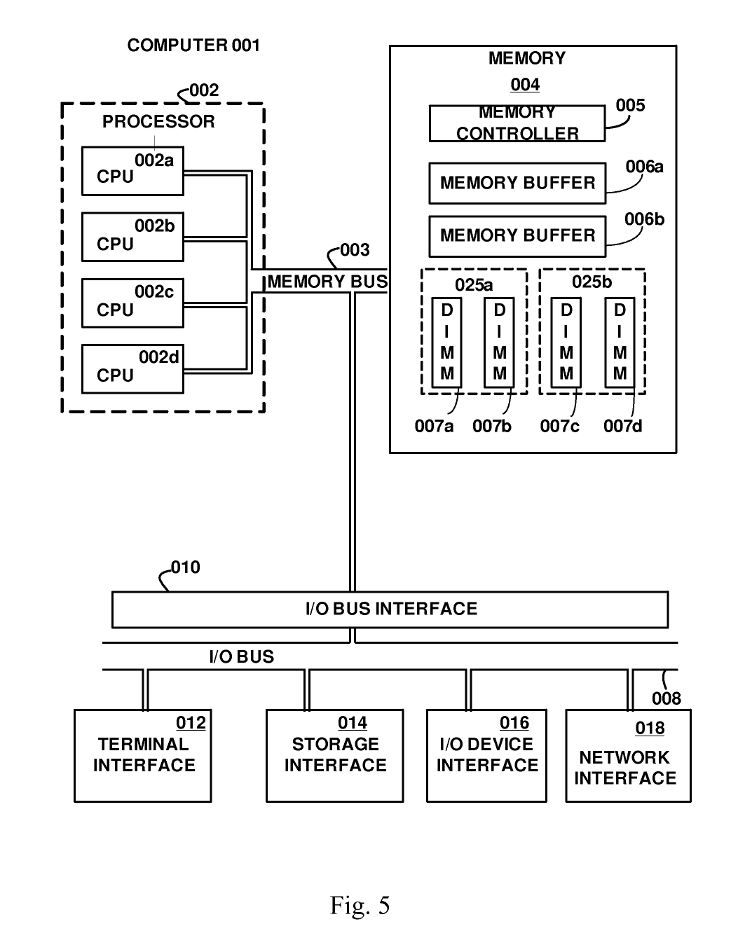

FIG. 5 depicts a high-level block diagram of an example system for implementing embodiments of the present disclosure. For instance, the computer system 001 can be used to implement one or more of the devices, systems and tools discussed herein. The mechanisms and apparatus of embodiments of the present invention apply equally to any appropriate computing system. The major components of the computer system 001 comprise one or more processors 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffer 006 and one or more memory devices 007. In the illustrated embodiment, the memory devices 007 may be dual in-line memory modules (DIMMs), which are a series of dynamic random-access memory (DRAM) chips 015a-015n (collectively referred to as 015) mounted on a printed circuit board and designed for use in personal computers, workstations, and servers. The use of DRAMs 015 in the illustration is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 5 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 5 is intended to depict the representative major components of an exemplary computer system 001. But individual components may have greater complexity than represented in FIG. 5, components other than or in addition to those shown in FIG. 5 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be an intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM 0015 may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

Embodiments described herein may be in the form of a system, a method, or a computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments are not intended to limit the present invention. Indeed, other alternative hardware and/or program environments may be used without departing from the scope of embodiments of the invention.

While the invention has been described with reference to the specific aspects thereof, those skilled in the art will be able to make various modifications to the described aspects of the invention without departing from the true spirit and scope of the invention. The terms and descriptions used herein are set forth by way of illustration only and are not meant as limitations. Those skilled in the art will recognize that these and other variations are possible within the spirit and scope of the invention as defined in the following claims and their equivalents.

What is claimed is:

1. A method of monitoring deployment of code onto a system, the method comprising:
receiving a serial identification number of the system, the system having a system type and a system status;
accessing a database to obtain code detail records of the system associated with the serial identification number;
receiving code details of the system;
analyzing the serial identification number, the code detail records and the code details of the system
identifying the system type and the system status from the code detail records and the code details of the system; and
identifying a suitable system update for the system, based on the system type and the system status.

2. The method of claim 1, further comprising:
installing the system update to the system; and
updating the code detail records of the system in the database to report the system update to the system.

3. The method of claim 2 further comprising:
receiving a recall on the system update;
notifying the system of the recall on the system update;
removing the system update from the system;
installing a second system update to the system; and
updating the code detail records of the system in the database to report the removing of the system update and installation of the second system update to the system.

4. The method of claim 1, wherein the suitable system update is no system update, the method further comprising:
notifying the system that the suitable system update is no system update.

5. The method of claim 1, wherein the system status comprises past and current code-levels of the system.

6. The method of claim 1, wherein the serial identification number and the code details are received from the system.

7. The method of claim 1, wherein a system agent responsible for monitoring, repairing, and updating the system collects information about the system, and wherein the serial identification number and code details are received by the system agent from the information about the system.

8. A system for monitoring deployment of code onto a system, the system comprising:
one or more processors configured with
a recipient tool adapted to receive a serial identification number of the system and code details of the system, the system having a system type and a system status;
a database adapted to provide code detail records of the system associated with the serial identification number;
an analyzing tool adapted to analyze the serial identification number, the code detail records and the code details of the system to identify the system type and the system status; and
an identification tool adapted to identify a suitable system update for the system, based on the system type and the system status.

9. The system of claim 8, further comprising:
an installation tool adapted to install the system update to the system, wherein the code detail records of the system in the database are updated to report the installation of the system update to the system.

10. The system of claim 9 further comprising:
a second recipient tool adapted to receive a recall on the system update;
a notification tool adapted to notify the system of the recall on the system update, wherein the installation tool removes the system update from the system, installs a second system update to the system, and the code detail records of the system are updated in the database to report the removing of the system update and the installation of the second system update to the system.

11. The system of claim 8, wherein the identification tool identifies no system update for the suitable system update and notifies the system that the suitable system update is no system update.

12. The system of claim 8, where the identification tool identifies past and current code-levels of the system for the system status.

13. The system of claim 8 further comprising:
a system agent tool adapted to monitor the system, repair the system, update the system, and collect information about the system, and wherein the serial identification number and code details are received by the system agent from the information about the system.

14. A computer program product, the computer program product comprising a computer readable storage medium having program code embodied therewith, the program code comprising computer readable program code configured to:
receive a serial identification number of the system, the system having a system type and a system status;
access a database to obtain code detail records of the system associated with the serial identification number;
receive code details of the system;
analyze the serial identification number, the code detail records and the code details of the system to identify the system type and the system status; and
identify a suitable system update for the system based on the system type and the system status.

15. The computer program product of claim 14, further configured to:
install the system update to the system; and
update the code detail records of the system in the database to report the system update to the system.

16. The computer program product of claim 15, further configured to:
receive a recall on the system update;
notify the system of the recall on the system update;
remove the system update from the system;
install a second system update to the system; and
update the code detail records of the system in the database to report the removing of the system update and installation of the second system update to the system.

17. The computer program product of claim 14, wherein the suitable system update is no system update, the computer program product further configured to:
notifying the system that the suitable system update is no system update.

18. The computer program product of claim 14, wherein the system status comprises past and current code-levels of the system.

19. The computer program product of claim 14, wherein the serial identification number and the code details are received from the system.

20. The computer program product of claim 14, wherein a system agent responsible for monitoring, repairing, and updating the system collects information about the system, and wherein the serial identification number and code details are received by the system agent from the information about the system.
